(19) United States
(12) Patent Application Publication
(10) Pub. No.: US 2009/0156970 A1
(43) Pub. Date: Jun. 18, 2009

(54) System and method for exercising eyes

(76) Inventor: Shannon E. Sullivan, Benicia, CA (US)

Correspondence Address: C. Bart Sullivan, 1543 Sherman Dr., Benicia, CA, 94510, US

(21) Appl. No.: 12/002,088

(22) Filed: Dec. 14, 2007

(51) Int. Cl. A61H 5/00

(52) U.S. Cl. 601/37

(57) ABSTRACT

A method and system to exercise and relax the eyes is provided. In one embodiment, a computer or video display system is configured to alter the way that a user's activity and tasks are displayed in order to exercise and/or relax the eyes and components of the eyes, such as the eye focusing muscles. For example, in one embodiment, images that relate to a user activity are displayed in a manner configured to cause the eyes to refocus and/or move while the user continues to perform the activity, with or without the user being aware their eyes are being refocused and/or moved. In another embodiment, images related to a user activity are displayed with the color, contrast, and/or brightness of the display changed over a predetermined time in a manner to relax the eyes, with or without the user being aware.

### BACKGROUND

The present invention relates to the field of vision, and in particular to apparatus and methods for eye care.

Nearly all animals utilize one or more eyes to visually perceive the world. Generally, for human eyes light passing through the cornea and lens is focused on a region of the back of the eye referred to as the macular region. The light is processed by rods and cones dispersed throughout the eye. The rods and cones generate signals in response to different spectrums of light and light intensity. The brain processes the signals generated by the rods and cones to perceive an image.

Under the brain's direction, the eye muscles shape the lens to focus the light. For visual acuity, if the focal point of the light is adjusted by the eye muscles to match the distance from the lens to the macular portion, the image may be brought into focus clearly without correction. However, if the eye muscles are unable to adjust the focal point of the image to the macular portion of the eye, then vision correction may be required to move the focal point the correct distance.

Generally, eyesight deteriorates as people age. For example, focusing on smaller and closer objects often becomes more difficult as people age, as the lens becomes less flexible. Eyes are also fatigued by close work at a fixed distance, such as computer work. For example, people spend hours focusing at the same distance, which generally leads to eye focusing fatigue. Glasses and contacts are the most common form of eye focusing correction. Focusing difficulties may be corrected in some instances using laser surgery procedures. For example, one surgical procedure referred to as LASIK surgery works by reshaping the cornea. Unfortunately, Lasik surgery does not work for all types of vision correction.

Conventional eye exercising systems and programs have been developed to help exercise external eye muscles. Such conventional eye exercising programs rely on movement of conventional images to exercise external muscles of the eyes. For example, some eye exercising programs have a user play an eye movement game designed to help exercise the eye. Unfortunately, these programs are not designed to exercise visual acuity, and are often not used by the user as such programs rely on having the user switch between such eye exercising programs and a previous activity. Switching between the eye exercising program and other user activity is often disruptive and annoying.

Therefore, there is a need for a simpler, more efficient, and flexible system and method for exercising and relaxing the eyes to help eyes remain healthy as people age.

### BRIEF SUMMARY

Embodiments of the invention provide a method and system for exercising and/or relaxing the eyes to help reduce eyestrain and fatigue while a user performs an activity or task unrelated to eye exercise and/or relaxation. In one embodiment, a computer adapted for two-dimensional or three-dimensional image processing modifies at least some portion of the information displayed on a display in a random depth, location, movement, color, and the like, such that one or more eye components (e.g., cornea, muscles, iris, lens, etc.) of a user observing the information may be exercised, relaxed, and/or moved without necessarily disturbing the user.

In one embodiment, the present invention provides a method of exercising the eyes that includes displaying one or more images associated with a user activity to a user while the user is performing an activity unrelated to eye exercise, and varying at least one display variable associated with the one or more images to exercise eyes of the user.

In one embodiment, the present invention provides a system for exercising the eyes. The system includes an image processing apparatus. The image processing apparatus is configured to output at least one image associated with a user activity to a user. In response to an eye activity signal, the image processing apparatus modifies the at least one image displayed to the user in order to exercise or relax the user's eyes while allowing the user to engage in the user activity.

In one embodiment, the present invention provides a computer-readable medium storing a set of code modules which when executed by a processor of a computer system cause the processor to generate a display of images to exercise or relax components of a user's eyes. The computer-readable medium includes code for outputting at least one image associated with a user activity to a user for observation thereof, wherein the user activity is not associated with eye exercise or eye relaxation, and code for modifying at least one display variable associated with the at least one image to generate a modified display of the at least one image, wherein the modified display is configured to exercise or relax the user's eyes.

These and other embodiments of the invention are described in further detail below.

### BRIEF DESCRIPTION OF THE DRAWINGS

FIG. 1 is a simplified block diagram of eye-exercising system in accordance with embodiments of the invention;

FIG. 2 is a high-level illustration of a memory portion of the eye-exercising system in accordance with embodiments of the invention;

FIG. 3 is a high-level flow diagram illustrating an embodiment of a method of exercising and/or relaxing eye components in accordance with embodiments of the invention;

FIG. 4 is a high-level flow diagram illustrating an embodiment of a method of exercising and/or relaxing eye components using two-dimensional and three-dimensional image displays in accordance with embodiments of the invention;

FIG. 5 is an illustration of varying user activity images in accordance with embodiments of the invention;

FIG. 6 is an illustration of varying a user display in accordance with embodiments of the invention;

FIG. 7 is an illustration of varying a user display in accordance with embodiments of the invention;

FIGS. 8A-8C illustrate varying user activity images and displays in accordance with embodiments of the invention;

FIG. 9 is an illustration of varying a three-dimensional display in accordance with embodiments of the invention; and

FIG. 10 is a high-level process block diagram illustrating an embodiment of a system for exercising and/or relaxing the eyes adjusted by feedback in accordance with embodiments of the invention.

### DETAILED DESCRIPTION OF EXEMPLARY EMBODIMENTS

Embodiments of the invention are directed to methods and systems used to exercise and/or relax the eyes by exercising and/or relaxing external and internal components of the eyes, such as external eye muscles and the cornea, and internal components such as the, lens, iris, rods, cones, and the like. For clarity, such external eye muscles, and internal components of the eyes are generally referred to herein as the eyes. In an embodiment, a display on a display screen is modified to exercise and/or relax the eyes of a user of the display screen with, or without, the user being aware of the display modification. Such exercising and/or relaxing external and internal components of the eyes may be used to help reduce eyestrain and eye fatigue, and may help maintain or improve the eye's visual acuity.

In one embodiment, at least one display variable associated with images associated with a task or activity that is not related to relaxing and/or exercising the eyes are varied so that the user's eyes are relaxed and/or exercised while the user continues to perform the task or activity. For example, the user may be performing a word processing activity while images and display associated with such word processing activity are varied in order to relax and/or exercise the user's eyes. In another example, the user may be playing a video game, or watching a movie, while the images and/or display associated with such video game or movie are varied in order to relax and/or exercise the user's eyes. In one embodiment, the environment lighting in the space e.g., room, office, etc.) used for such user activity may be varied for example by varying illumination intensity and/or color to further enhance changes to the images and/or display.

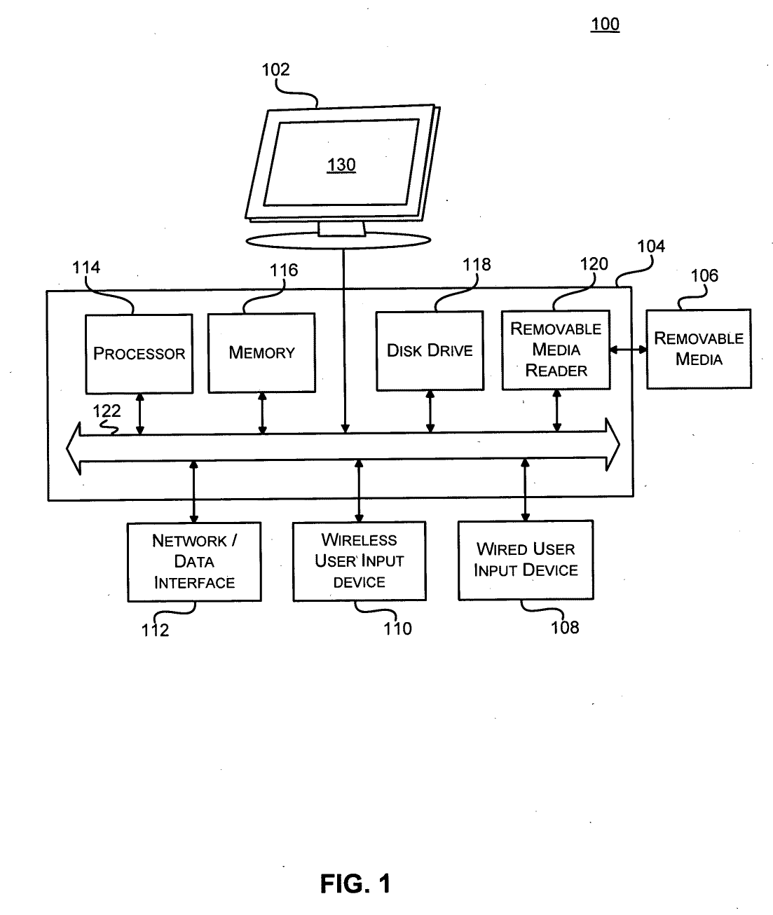

FIG. 1 is a block diagram of an eye-exercising system 100 according to an embodiment of the present invention. Eye-exercising system 100 depicted in FIG. 1 is merely illustrative of an embodiment incorporating the present invention and is not intended to limit the scope of the invention as recited in the claims. One of ordinary skill in the art would recognize other variations, modifications, and alternatives.

As shown in FIG. 1, eye-exercising system 100 may include eye-exercising driver 104. Eye-exercising driver 104 may include one or more processors 114 and one or more volatile memory storage areas such as memory 116. Memory 116 may be any type of memory such as Random Access Memory (RAM), non-volatile memory, volatile memory, and the like. Memory 116 may be configured to store one or more computer programs for execution by processor 114, such as a program configured to generate eye-exercise activities in accordance with embodiments of the present invention, examples of which are described herein. Eye-exercising driver 104 may further include one or more nonvolatile memory storage areas such as disk drives 118, a removable media reader 120 (providing access to removable media 106), and an electrical bus 122 interconnecting the above components.

In one set of embodiments, disk drive 118 and/or removable media 106 may be configured to store a representation of one or more eye-exercising activities, patterns, images, visual effects, and the like in accordance with embodiments of the present invention. Removable media 106 may correspond to any type of nonvolatile storage media or device, such as optical media (e.g., CD-ROM, DVD-ROM, Blu-Ray Disc, HD-DVD, etc.), nonvolatile flash media (e.g., CompactFlash, SD, MemoryStick. etc.), removable hard disks, or the like.

Memory 116, disk drives 118, and removable media 106 are examples of tangible media for storage of data, audio/video files, computer programs, and the like. Other types of tangible media include floppy disks, USB drives, removable hard disks, optical storage media such as CD-ROMS and bar codes, semiconductor memories such as flash memories, read-only-memories (ROMS), battery-backed volatile memories, networked storage devices, and the like.

In various embodiments, eye-exercising driver 104 may be communicatively coupled with one or more wired user input devices 108 and/or one or more wireless user input devices 110. Wired user input device 108 may be any type of input device capable of communication via a wired connection/protocol (e.g., USB, Firewire, PS/2. etc.) such as a keyboard, remote control, mouse, a trackball, a track pad, a joystick, a game controller, a drawing tablet, microphone, and the like.

Wireless user input device 110 may be any type of input device capable of communication via a wireless connection/protocol (e.g., infrared, radio frequency (RF), Bluetooth, etc.) such as a wireless remote control, a wireless keyboard, wireless mouse, a wireless game controller, and the like. In various embodiments, user input devices 108, 110 allow a user to select objects, icons, text and the like that graphically appear on a display via one or more input commands such as a button click or the like. In some embodiments, user input device 108 may include controls (e.g., buttons, switches, etc.) physically located on eye-exercising driver 104.

In further embodiments, one or more network/data interfaces 112 may be provided for communicatively coupling eye-exercising driver 104 with other devices. For example, network/data interface 112 may couple eye-exercising driver 104 with one or more computers on a computer network, a FireWire device, a Satellite cable connection, an optical cable, a wired-cable connection, or the like. Network/data interface 112 may include an Ethernet-based network adapter, modem (e.g., telephone, satellite, cable, ISDN, etc.), (asynchronous) digital subscriber line (DSL) unit, FireWire interface, USB interface, CableCard™ interface, and the like. Further, network/data interface 112 may be physically integrated on a motherboard of eye-exercising driver 104, or may be a software program such as soft DSL or the like.

Network/data interface 112 may be coupled with one or more data storage locations such as web servers and the like via one or more communication networks 152, including local-area networks; wide-area networks, such as the Internet or cellular data networks; and virtual private networks. In some embodiments, network/data interface 112 may be configured to receive analog or digital image data to be decoded and output to viewers via image output device 102. Image output device 102 may be any output device configured to display an image such as a monitor, television, movie screen, display on a portable device such as a cellular phone or game, and the like.

In one embodiment, such network/data interfaces 112 may be used to connect eye-exercising driver 104 to another device, such as a room illumination control, used to control the ambient light in a room where the user is observing the display, such that the eye-exercising driver 104 may control the illumination in the space where the user is performing the activity. For example, eye-exercising driver 104 may be used to control the illumination of s space where a user is observing user activity images displayed on image output device 102 such as a computer monitor, television, movie screen, and the like.

Embodiments of eye-exercising system 100 may implement processors 114 and peripheral components, such as memory 116, network/data interface 112, graphics, audio, and video peripherals as separate components, components combining two or more of these functions, and/or software programs implementing some or all of the functionality of these peripherals.

In an embodiment, eye-exercising driver 104 may also include software that enables communications over communication network/data interface 112 such as the SMB/CIFS, NFS, ZeroConf, HTTP, TCP/IP, RTP/RTSP protocols, wireless application protocol (WAP), and the like. In alternative embodiments of the present invention, other communications software and transfer protocols may also be used, for example IPX, UDP or the like.

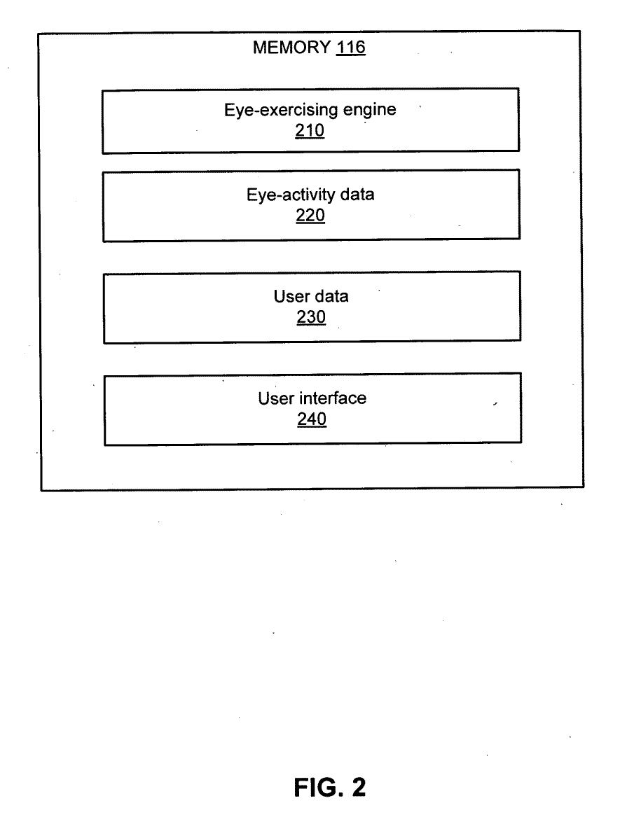

FIG. 2 is a high-level illustration of memory 116 which includes an eye-exercising engine 210, eye-activity data 220, user data 230, and a user interface 240. As described further below, eye-exercising engine 210 is a software engine that facilitates a user in exercising and relaxing muscles associated with eye movement and eye focusing. In one embodiment, eye-exercising engine 210 operates to relax and/or exercise the user's eyes while the user is performing a activity such as word processing, computer programming, computer-aided design (CAD), and the like.

In one embodiment, eyesight exercising-engine 210 may be a stand alone program included in an operating system, library, daemon, or background process application, may be a plug-in program used to modify and enhance the operation of other programs, or may incorporated as part of other programs source code. For example, eye-exercising engine 210 may be configured to be incorporated into, operate in conjunction with, or modify the operation of visual display and user interface programs such as Microsoft Windows, OS X user interface programs, Linux user interface, and the like.

In other embodiments, eye-exercising engine 210 may be configured to be incorporated into, operate in conjunction with, or modify, the operation of user application programs such as word processors, spreadsheet programs, browsers, software development interfaces, building illumination controls, and the like. In an embodiment, eye-exercising engine 210 may be configured to be incorporated into, operate in conjunction with, or modify the operation of video games, graphical interfaces used in portable devices, and other types of systems that use video such as television, motion pictures, and the like.

In an embodiment, eye-activity data 220 may be digital data including but not limited to virtually any data that may be displayed such as electronic documents, photographs, music, videos, creative assets, financial data, business and personal records, and program source and executable code. As will be described below, eye-activity data 220, may be stored in any suitable location such as memory 116, disk drives 118, removable media 106, and the like.

User data 230 may be any suitable data capable of identifying a user or associating a user to one or more software programs, movies, videos games, and the like. User data 230 may contain information pertaining to the user's eyesight, age, eyeglass prescription, and the like. In an embodiment, user data 230 may include eye-relaxation and eye-exercising activities pertinent to a user. For example, a user data 230 may contain user settings for eye-exercising engine 210.

In an embodiment, user interface 240 may be any suitable interface used for example to operate eye-exercising engine 210, eye-exercising system 100, and the like. User interface 240 may be a graphical user interface (GUI) such as a browser program that provides icons and other graphical information to a user, for example on output device 102, to operate a software program such as eye-exercising engine 210. User interface 240 may also include other interfaces such as a command line interface. In further embodiments, user interface 240 may be omitted. Instead, eye-exercising engine 210 may be configured to interact directly with an operating system or a software application. In one embodiment, eye-exercising engine 210 may operate transparently to the user and rely on the user interface of the operating system or the application.

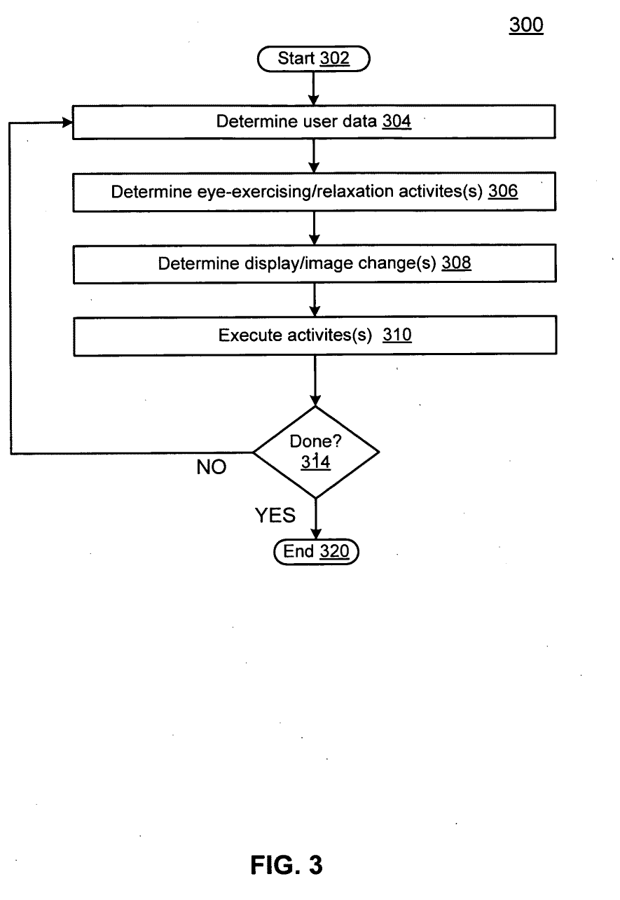

FIG. 3 is a high-level flow diagram illustrating an embodiment of a method 300 of exercising and/or relaxing the eyes. Method 300 may be entered into at step 302 when a user, for example, initiates a computer program activity such as word processing, operates a video game, activates a movie, and the like. In other embodiments, method 300 may be used as part of a vision therapy program.

At step 304, method 300 obtains user data to determine the user. For example, method 300 obtains user information from user data 230. In another embodiment, bio-metric data such as finger print, eye-cornea image, and the like, is obtained from a user to determine the user. Method 300 in other embodiments may associate a particular program, computer, workstation, activity, and the like using, for example, a user login. For example, a method 300 may use a user login identification used to allow access to a computer, program, file, and the like.

At step 306, method 300 determines one or more eye-exercising activities. For example, method 300 may obtain a user may have a pre-selected activity having user-defined options. In an embodiment, such user options may be obtained from user data 230. Optionally, a default eye-exercising program may be used having pre-configured eye exercising/relaxation activities.

In another embodiment, eye-exercising activities may be varied according to the type of program a user is using. For example, one or more types of eye exercising/relaxation activities may be used while a user operates a word processor, and other eye-exercising/relaxation activities may be used when a user is operating a computer aided design program, graphics art program, and the like.

At step 306, method 300 determines the types of changes to the image display, room illumination, and the like, to exercise and/or relax components of the eyes such as the external eye muscles, and/or internal components of the eye such as the lens, iris, rods, cones, and the like. In one embodiment, method 300 varies the display 130 from output device 102 to cause the eyes to change focus and/or move the eyes. Method 300 may vary any number and combination of display variables such as color, focus, depth of field, brightness, blur, resolution, contrast, image size, and the like, to cause the user's eyes to vary focus and/or movement. In some embodiments, such display variable cause the user's eyes to vary in focus and/or movement using monocular and binocular visual clues.

In one example described further below, a display variable, such as brightness or color, of a display and/or room may be varied over time to cause the pupil of the eye to enlarge and contract which in turn may cause a change in eye focus. Such changes in eye motion and focus may be slight or more exaggerated. For example, such changes in eye motion and focus may be subtle in order to not disturb the user in performing an activity such as performing tasks on a computer, playing a video game, watching a movie, and the like. In other embodiments, method 300 may interact with a room illumination control in order to vary the environment lighting intensity and/or color. For example, method 300 may control the illumination level of a room where the user is observing user activity images being displayed.

In some embodiments, method 300 uses images and optical illusions designed to fool or trick the user's brain into varying the eye's focus and/or movement, some of which are described herein. For example, a user may be presented a two-dimensional image such as an autostereogram (e.g. wall paper autostereogram, random dot autostereogram). The autostereogram combined with a parallel viewing method (e.g. divergence method), where the eyes line of sight move outward toward parallel and meet in the distance at a point well behind and beyond an image, cross-viewing (e.g. cross-eyed method), and the like, may be used to urge the user's eyes to focus differently.

For three-dimensional (3D) systems (e.g., 3D geometry displays, stereoscopic displays, etc.), method 300 may alter 3D images to cause the eyes to focus and move according to one or more eye-exercising/relaxation activities. For example, method 300 may cause 3D images displayed on display 130 to change depth relative one another to exercise and/or relax the eyes. In another embodiment, method 300 may cause 3D images displayed on display 130 to change position over time relative one another to exercise and/or relax the eyes.

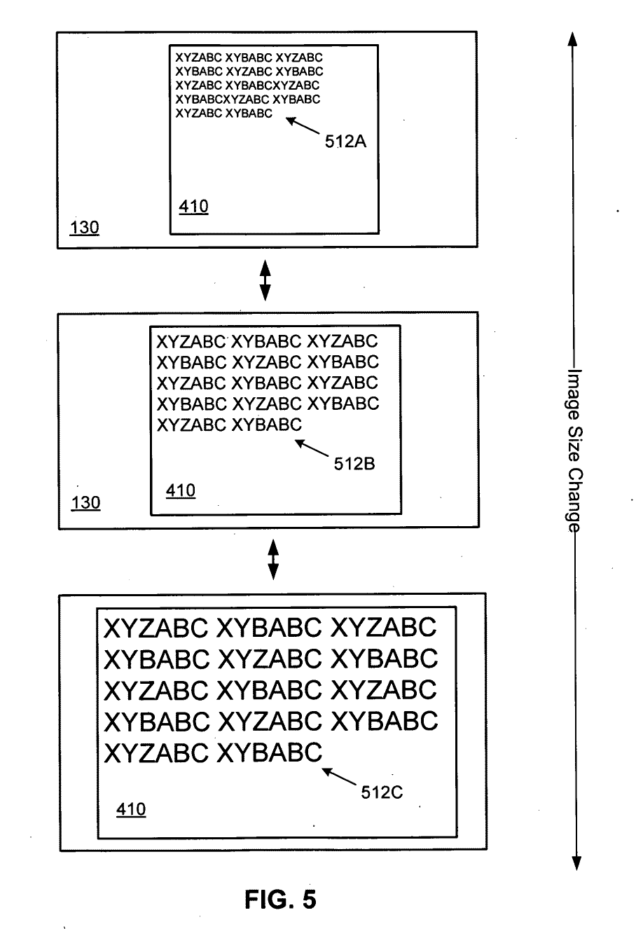

In one embodiment, at step 308, method 300 determines at least one display variation to exercise and/or relax the eyes without the user having to change tasks or activities. For example, as illustrated in FIG. 5, a user may be operating a word processor where method 300 varies the size of the text 512 over time. Illustratively, FIG. 5 shows text 512A-C increasing and decreasing in size over time. Such changes in text size may involve some or all of the displayed text. In an embodiment, such text changes are done gradually to the text being displayed so as to not necessarily disturb the user. In some configurations, method 300 may set the text size change levels, or alternatively, such size changes may be selected by the user.

At step 310, method 300 executes such eye-exercising activities. In one embodiment, such eye-exercising activities are executed continuously, whereas in other embodiments, such eye-exercising activities are executed at different time intervals, or in relation to different user activities. For example, such eye-exercising activities may be executed as long as a user is operating a computer or program, or alternatively, such eye-exercising activities may be executed at different times. At step 314, if method 300 is finished, then method 300 ends at step 320. However, is method 300 is not finished, then at step 314, method 300 returns to step 304.

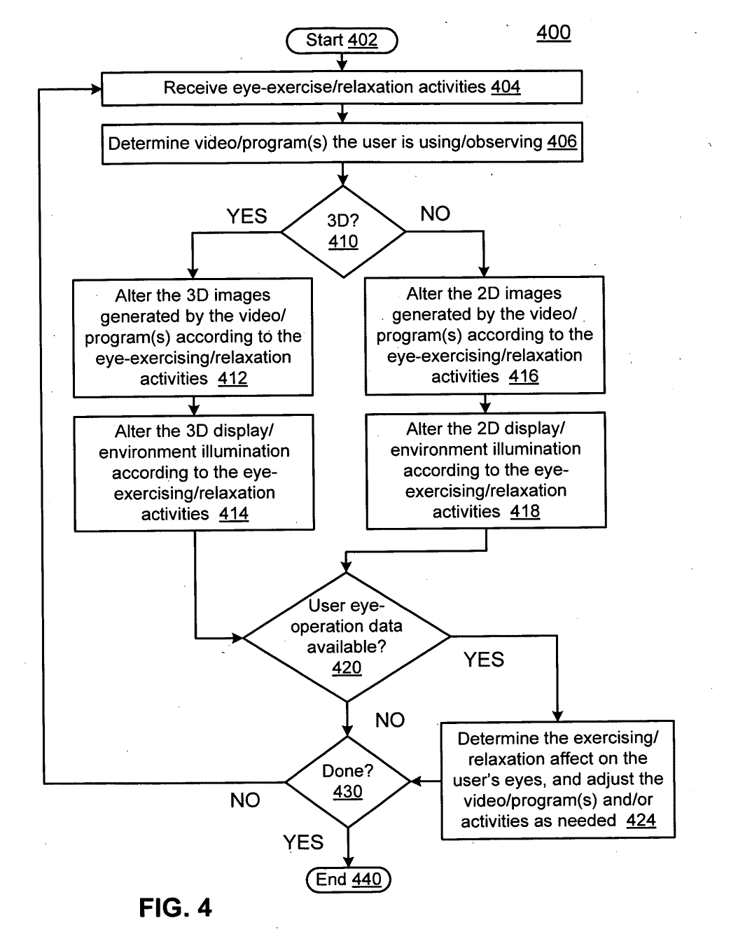

FIG. 4 is a high-level flow diagram illustrating an embodiment of a method 400 of determining what modifications are needed to user activity images and/or display in order to relax and/or exercise a user's eyes. Method 400 may be entered into at step 402 when a user, for example, initiates a computer program such as word processor, operates a video game, activates a video, activates a movie, and the like. In other embodiments, method 400 may be used as part of a vision therapy program.

At step 404, method 400 receives one or more eye-exercising activities. Such eye-exercising activities may be derived from data storage such as memory 116, disk drive 118, removable media 106, and the like. For example, such activities may be retrieved from eye-activity data 220. Alternately, such eye-exercising activities may be associated with the software programs the user is operating. As an example, a user may activate a word processing program having an integrated eye-exercising activity configured to work cooperatively with the word processing program.

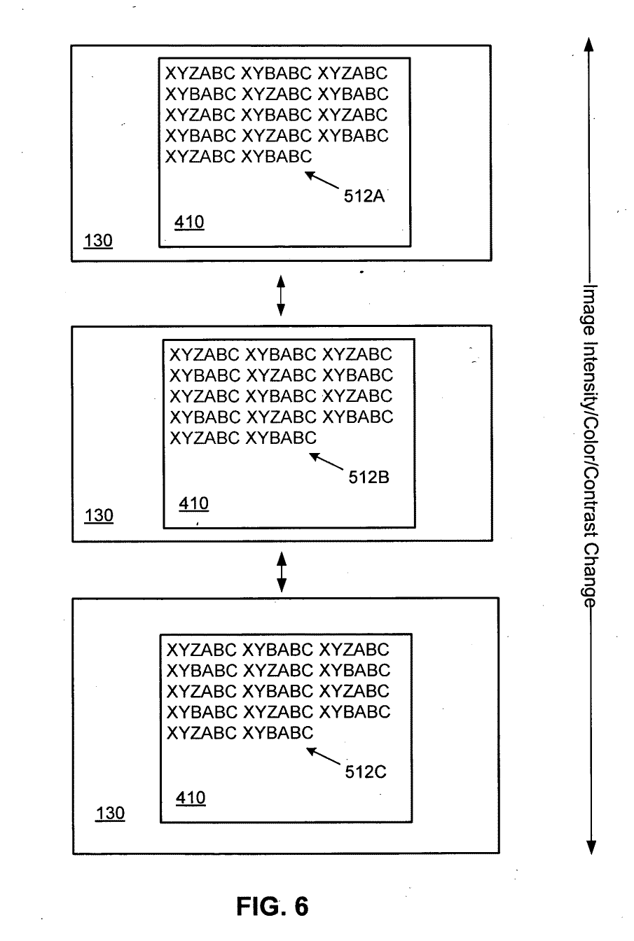

Illustratively, referring to FIG. 5, as described herein, such word processing program may alter the size of text 512 over time to cause the user's eyes to vary in movement and/or focus. In FIG. 5, such text changes size is illustrated by changes to text 512A-512C. Other attributes of such text may be changed to cause the user's eyes to vary in movement and/or focus. For example, referring to FIG. 6, attributes of text 512 such as color, contrast, intensity, focus, may be varied in order to provide image variation to the user's eyes.

At step 406, method 400 determines which video or image programs the user is using or observing. For example, the user may be using a computer system and operating one or more computer software applications such as a web browser, word processor, spreadsheet program, photo image manipulation program, video program, and the like. Alternatively, the user may be operating a video game console, viewing a movie from a DVD player, and the like.

At step 410, method 400 determines if the user is operating programs or observing images on a two-dimensional (2D) or three-dimensional (3D) system (e.g. 3D, stereoscopic systems, etc.) If the user is operating or observing a 3D display, method 400 proceeds to step 412, described below. If the user is utilizing a 2D system, method 400 proceeds to step 416. In one embodiment, at step 416, method 400 determines how to alter one or more 2D programs the user is operating or 2D video images the user is observing in order to relax and/or exercise the user's eyes while the user continues to operate such programs or observing such 2D images. For example, method 400 may alter one or more 2D image and display properties. Illustratively, as shown in FIG. 5, method 400 may alter the size of text images 512A-C, or may alter the color, intensity, contrast, etc., of such text images as illustrated in FIG. 6.

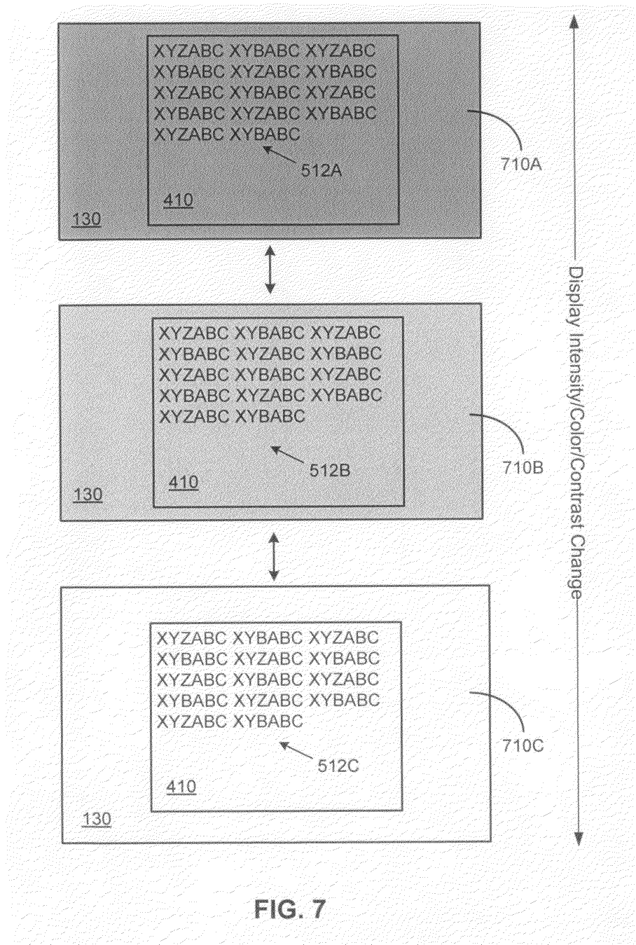

In one embodiment, at step 418 method 400 may vary properties of 2D display 130 in order to relax and/or exercise the user's eyes while the user continues to operate such programs or observe such 2D images. For example, as illustrated in FIG. 7, method 400 may vary the brightness, contrast, and color of display 130 may be changed over time, as illustrated in display output 710A-C. Such variations may cause the user's pupils to dilate over time, which may cause variations in the user's eye focusing and/or movement. In other embodiments, method 400 may change the illumination in a room (e.g., environment lighting), along with such varying properties of 2D display 130 in order to help relax and/or exercise the user's eyes. For example, decreasing the brightness of the display 130, while decreasing the illumination of the room, may be used to exercise and/or relax the eyes.

In an embodiment, as illustrated in FIG. 6 and FIG. 7, the color of display 130 and/or the color of the user's activity images 512 may be varied over time. For example, the color of display 130 and/or the color of the user's activity images 512 and/or display 130 may be shifted between red, green, and blue color over a period of time. Such color shift may cause the user's eyes activate different rods and cones of the eyes which may cause the user's eyes to refocus and components of the eyes to adjust. One of ordinary skill in the art would recognize many variations, modifications, and alternatives.

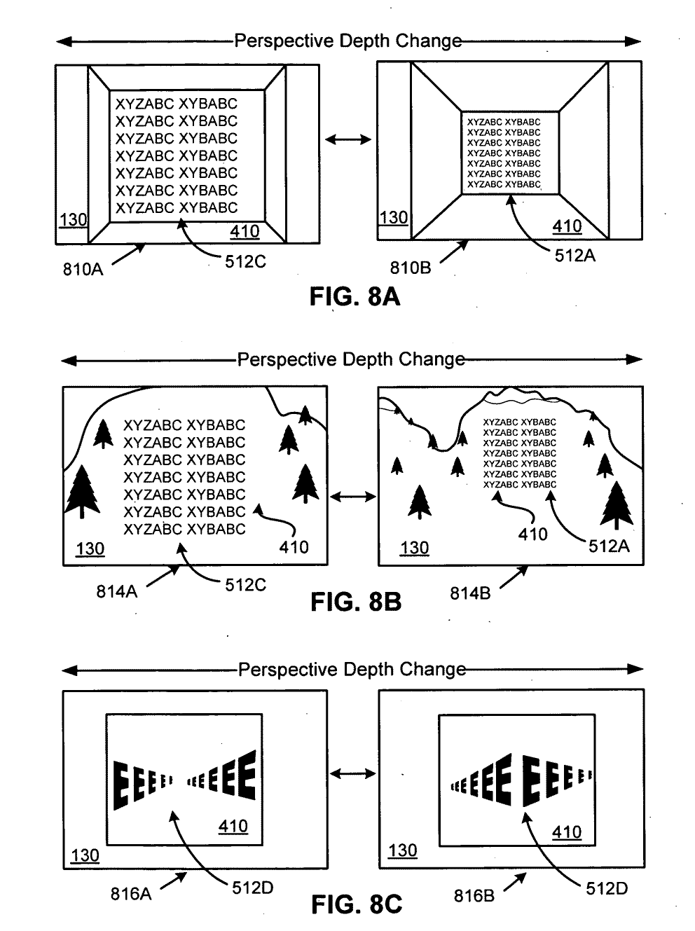

In one embodiment, at step 418 method 400 may integrate activity images 512 the user is operating with (e.g., text, photos, etc.) as part of an activity such as a word processing task, or observing (e.g. video) with other images in order to relax and/or exercise the user's eyes while the user continues to operate or observe the user's activity oriented images 512. For example, as illustrated in FIG. 8A, the user's activity images 512 of a program display 410 may be integrated with a perspective display which varies between a shallow perspective 812A, and farther away perspective 812B to give the user the illusion of the activity images 512 varying in distance from the user.

In one embodiment, to exercise the muscles external to the eyes, the perspective displays 812A-B may be moved to different positions on display 130. In one embodiment, such movement may be gradual so as to not disturb the user's activity or task. In other embodiments, such movement may be exaggerated so the user is notified that the method 300 is exercising the user's eyes while the user is performing the activity or task.

In other embodiments, at step 418, method 400 may integrate activity images 512 with images configured to provide an optical illusion. For example, as illustrated in FIG. 8B, the user's activity images 512A of a program display 410 may be integrated with an image conveying a far away object or scene, such as a mountain scene. Such far way object or scene may be varied between a close-up perspective 814A, and farther away perspective 814B to provide an illusion to the user of the activity images 512A varying in distance. Alternatively, as illustrated in FIG. 8C, the user's activity images 512D of a program display 410 may be integrated with an image conveying change in depth. For example, the user's activity images 512D may be varied in size to convey an illusion of depth variation, by providing for example, a perspective view of user activity images 512D to the user.

Such integrated scenes, such as integrated perspective displays, integrated distance scenes, and the like, coupled with other display changes such as color changes, contrast changes, display brightness changes, and the like, and/or environment illumination may relax and/or exercise the user's eyes, while the user continues to operate or observe the user's activity images 512.

Similar to movement of perspective displays 812, to help exercise the muscles external to the eyes, the perspective displays 814 and 816 may be moved to different positions on display 130. In one embodiment, such movement may be gradual so as to not disturb the user's tasks or activities. In other embodiment, such movement may be exaggerated so the user is notified that the method 300 is exercising the user's eyes.

Referring to FIG. 4, if at step 410 the user is operating with 3D images and/or systems, method 400 proceeds to step 412. In one embodiment, at step 412, method 400 determines how to alter one or more 3D programs the user is operating, and/or 3D video images the user is observing, in order to relax and/or exercise the user's eyes while the user continues to operate such programs or observing such 3D images. For example, similar to step 416, method 400 may alter image and display properties from such 3D image programs and systems in order to relax and/or exercise the user's eyes.

In one embodiment, at step 414 method 400 may vary properties of a 3D display 130 in order to relax and/or exercise the user's eyes while the user continues to operate such 3D programs or observing such 3D images. For example, as illustrated in FIG. 7, for 3D images method 400 may vary the brightness and/or color values of the display 130 over time, similar to display changes illustrated in display variation 710A-C, and/or environment lighting. Such variations may cause the user's pupils to dilate over time, which may cause variations in the user's eye focusing. In other embodiments, the color of display 130 and/or the color of the user's activity images 512 may be varied over time. For example, the color of display 130 and/or the color of the user's activity images 512 may be shifted between red and green over a period of time. Such color shift may activate different rods and cones of the eyes, which may exercise and/or relax the user's eyes. One of ordinary skill in the art would recognize many variations, modifications, and alternatives.

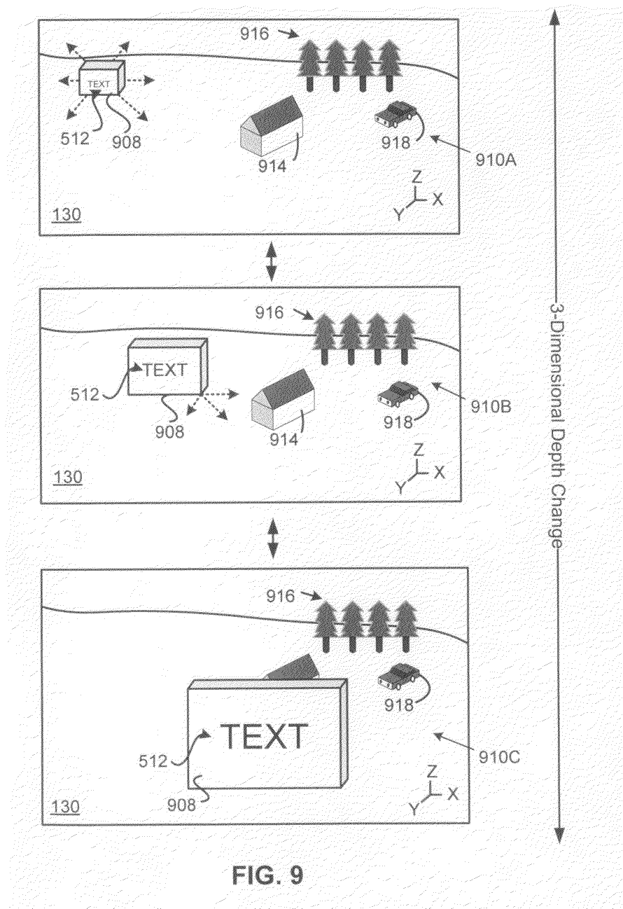

In other embodiments, at step 414, method 400 may integrate activity images 512 such as word processing text, spreadsheet data, email text, photos, icons, and the like with 3D images configured to provide a depth change illusion. As illustrated in FIG. 9, the user's activity images 512 of a 3D program display 908 may be integrated with an image conveying far away objects or scenes, such as a mountain scene, landscape scene, outer space scene, ocean scene, and the like. In another example, as illustrated in FIG. 9, activity images 912 move (e.g., float, hover, etc.) with a 3D display window 910A-C from a first size and position to a different size and position over an outdoor scene, while background images of the outdoor scene such as 3D house 914, 3D trees 916, and 3D car 918 remain about constant in position and size. In one embodiment, blur may be used to enhance depth change by simulating and/or enhancing depth of field to the user.

Such 3D integrated scenes, such as integrated 3D displays, integrated 3D distance scenes, and the like, coupled with other display changes such as color changes, contrast changes, display brightness changes, and the like, may be configured to relax and/or exercise the user's eyes while the user continues to operate or observe the user's activity images 512.

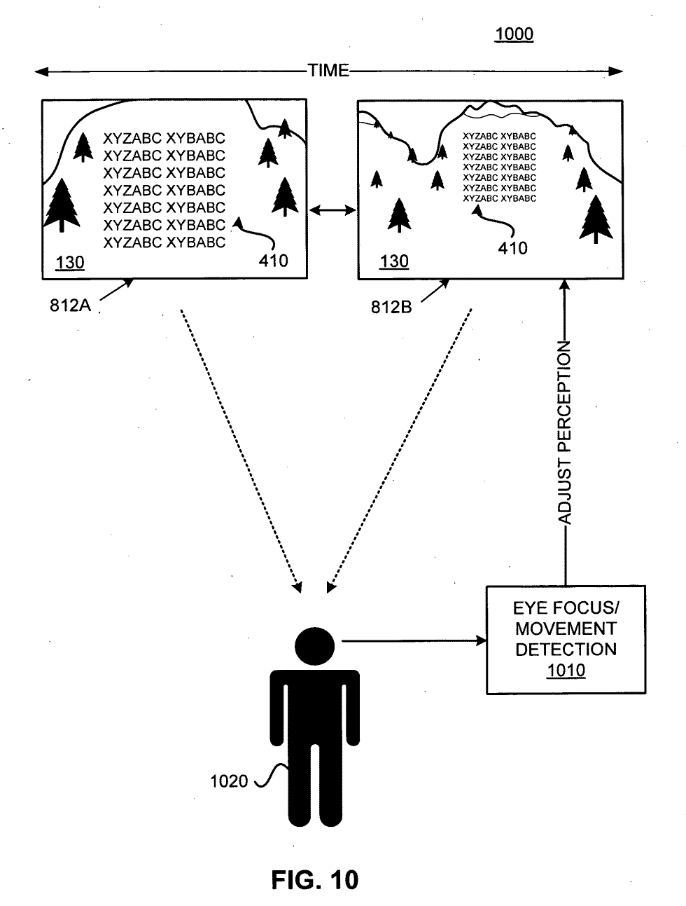

In one embodiment, from either step 414 or step 418, if user eye-operation data is available at step 420, method 400 proceeds to Step 424, otherwise method 400 proceeds to step 430 described below. At step 424 method 400 may use feedback to adjust the one or more eye-exercising activities. For example, FIG. 10 illustrates an eye movement/focusing feedback system 1000. In one embodiment, eye movement/focusing feedback system 100 may include eye-exercising system 100 coupled with an eye-movement/focusing detection apparatus 1010. In operation, as user activity images on display 130 are varied over time, eye-movement/focusing detection apparatus 1010 may be configured to detect movement and/or changes in the eyes of the user 1020. For example, eye-movement/focusing detection apparatus 1010 may detect changes in focus, pupil dilation, eye movement, and the like, and provided signals indicative of such changes to eye-exercising system 100 for processing.

Eye-movement/focusing detection apparatus 1010 may include any detection device suitable for detecting movement and/or changes to the user's eyes. For example, eye-movement/focusing detection apparatus 1010 may include a pair of glasses configured to measure changes to external and/or internal components or the user's eyes.

In one embodiment, eye-exercising system 100 may be configured to vary the display 130 until the user's eye movements, etc., are within a predefined threshold of the one or more eye-exercising activities. For example, such feedback may be used to by the one or more eye-exercising activities to help the eyes reach a target amount of movement, focusing change, relaxation, etc., over a given period of time. One of ordinary skill in the art would recognize many variations, modifications, and alternatives. If method 400 is done at step 430, method 400 ends at step 440. If method 400 is not done, then method 400 proceeds to step 404.

Further aspects of embodiments of the invention are illustrated in the attached figures. Additional embodiments can be envisioned to one of ordinary skill in the art after reading the attached documents. In other embodiments, combinations or sub-combinations of the above disclosed invention can be advantageously made. The block diagrams of the architecture and flow charts are grouped for ease of understanding. However it should be understood that combinations of blocks, additions of new blocks, re-arrangement of blocks, and the like are contemplated in alternative embodiments of the present invention.

The specification and drawings are, accordingly, to be regarded in an illustrative rather than a restrictive sense. It will, however, be evident that various modifications and changes may be made thereunto without departing from the broader spirit and scope of the invention.

Any of the above described steps may be embodied as computer code on a computer readable medium. The computer readable medium may reside on one or more computational apparatuses and may use any suitable data storage technology.

The present invention can be implemented in the form of control logic in software or hardware or a combination of both. The control logic may be stored in an information storage medium as a plurality of instructions adapted to direct an information processing device to perform a set of steps disclosed in embodiment of the present invention. Based on the disclosure and teachings provided herein, a person of ordinary skill in the art will appreciate other ways and/or methods to implement the present invention.

A recitation of “a”, “an” or “the” is intended to mean “one or more” unless specifically indicated to the contrary.

All patents, patent applications, publications, and descriptions mentioned above are herein incorporated by reference in their entirety for all purposes. None is admitted to be prior art.

What is claimed is:

1. A method of exercising and relaxing the eyes, the method comprising:
outputting at least one image associated with a user activity to a user for observation thereof, wherein the user activity is not associated with eye exercise or eye relaxation; and
modifying at least one display variable associated with the at least one image to generate a first modified display of the at least one image, wherein the first modified display is configured to exercise or relax the eyes of the user.

2. The method of claim 1, wherein the at least one image comprises images generated by a software program, a video program, and combinations thereof.

3. The method of claim 1, wherein the user activity comprises activities associated with a computer, activities associated with a video output device, activities associated with a video game console, and combinations thereof.

4. The method of claim 1, wherein modifying the at least one display variable comprises automatically modifying the brightness or color of at least a portion of a display used to display the at least one image to the user.

5. The method of claim 1, wherein modifying the at least one display variable comprises modifying the display of the at least one image to vary a perception of image distance from the user for at least a portion of the at least one image.

6. The method of claim 1, wherein modifying comprises combining the at least one image with other images to form a modified image display configured to vary a depth or position perception of the at least one image to the user.

7. The method of claim 1, wherein modifying comprises displaying a version of the at least one image moving across at least a portion of a display, appearing to move closer or farther from the user, and combinations thereof.

8. The method of claim 1, further comprising adjusting the first modified display in response to eye-component activity to generate a second modified display.

9. A system for exercising the eyes, the system comprising:
an image processing apparatus, wherein the image processing apparatus is configured to output at least one image associated with a user activity to a user; wherein in response to an eye activity signal, the image processing apparatus modifies the at least one image displayed to the user in order to exercise or relax the user's eyes while allowing the user to engage in the user activity.

10. The system of claim 9, wherein the at least one image comprise images generated by at least one of a software program, a video game program, a video play program, and combinations thereof.

11. The system of claim 9, wherein the image processing apparatus comprises at least one of a computer, a video processing apparatus, a video game system, and combinations thereof.

12. The system of claim 9, wherein the at least one image is configured to be displayed on a two-dimensional display system or displayed on a three-dimensional display system.

13. The system of claim 9, wherein the user activity comprises activities provided by one or more software programs configured to provide activities other than activities related to eye exercise or eye relaxation.

14. The system of claim 13, wherein the user activities comprise other user activities related to text editing, image manipulation, video game play, image observation, and combinations thereof.

15. A computer-readable medium storing a set of code modules which when executed by a processor of a computer system cause the processor to modify a display of user activities to exercise and relax at least some components of a user's eyes, the computer-readable medium comprising:
code for outputting at least one image associated with a user activity to a user for observation thereof, wherein the user activity is not associated with eye exercise or eye relaxation; and
code for modifying at least one display variable associated with the at least one image to generate a modified display of the at least one image, wherein the modified display is configured to exercise or relax the user's eyes.

16. The computer-readable medium of claim 15, wherein the at least one image comprises images generated by a software program, a video program, and combinations thereof.

17. The computer-readable medium of claim 15, wherein the user activity comprises activities associated with a computer, activities associated with a video output device, activities associated with a video game console, and combinations thereof.

18. The computer-readable medium of claim 15, wherein code for modifying the at least one display variable comprises code for automatically modifying the brightness or color of at least a portion of a display used to display the at least one image to the user.

19. The computer-readable medium of claim 15, wherein code for modifying the at least one display variable comprises code for modifying the display of the at least one image to vary the user's perception of the distance of at least a portion of the at least one image from the user.

20. The computer-readable medium of claim 15, wherein code for modifying comprises code for combining the at least one image with other images to form a modified image display configured to vary the user's depth or position perception of the at least one image.
